(19) United States
(12) Patent Application Publication
(10) Pub. No.: US 2025/0061579 A1
(43) Pub. Date: Feb. 20, 2025

(54) IMAGE PROCESSING APPARATUS, AND METHOD FOR CONTROLLING IMAGE PROCESSING APPARATUS

(71) Applicant: CANON KABUSHIKI KAISHA, Tokyo (JP)

(72) Inventor: AYUKO ISHII, Kanagawa (JP)

(21) Appl. No.: 18/797,398

(22) Filed: Aug. 7, 2024

(30) Foreign Application Priority Data
Aug. 14, 2023 (JP) 2023-131848

(51) Int. Cl. G06T 7/11

(52) U.S. Cl. CPC G06T 7/11; G06T 2207/10008; G06T 2207/20132

(57) ABSTRACT

An image processing apparatus, has: a scan control unit which conducts control to scan a scan target; and an output unit which, even in a case where there is no operation of designating a cropping region from a user, crops, from an image obtained by scanning in a state where a book document and a board are placed on a platen glass, a portion obtained by deleting a part on an opposite side to the board in a portion corresponding to the book document, and outputs the cropped portion.

### BACKGROUND

### Field

The present disclosure relates to an image processing apparatus and a method for controlling an image processing apparatus, and particularly relates to control in a case of reading a book document.

### Description of the Related Art

There is an opportunity where a thick book (book document) such as a dictionary, an encyclopedia, or a textbook is copied. It is not easy to read or copy a thick book document with high image quality because of its thickness.

Japanese Patent Laid-Open No. H11-109727 proposes that a region corresponding to a gutter portion (central folded portion) between double spread pages of a thick book (book document) with light to change the region to a white band portion (central erased portion) to obtain a high image quality.

### SUMMARY

In the case where a thick book document is read, it is difficult to precisely crop a range of a single target page which is desired to be read or copied. For example, there is a problem that a thick part of a book document outside the target page on the front edge side (a side on the opposite side to a “gutter portion”, which is a binding portion) of the book document is read or copied.

An image processing apparatus according to one aspect of the present disclosure has: a scan control unit which conducts control to scan a scan target; and an output unit which, even in a case where there is no operation of designating a cropping region from a user, crops, from an image obtained by scanning in a state where a book document and a board are placed on a platen glass, a portion obtained by deleting a part on an opposite side to the board in a portion corresponding to the book document, and outputs the cropped portion.

Further features of the present invention will become apparent from the following description of exemplary embodiments with reference to the attached drawings.

### BRIEF DESCRIPTION OF THE DRAWINGS

FIGS. 1A and 1B are diagrams for explaining scan of a book document;

FIG. 2 is a schematic configuration diagram of a reading system;

FIG. 3 is a diagram showing the relationship of FIGS. 3A and 3B;

FIGS. 3A and 3B are flowcharts of an entire processing of an image reading apparatus;

FIGS. 4A to 4E are flowcharts showing a detail of crop processing for scan with board and schematic diagrams showing a range of data to be processed; and

FIGS. 5A to 5C are diagrams showing examples of display of a screen displayed on an image processing apparatus in a case of executing book copy.

### DESCRIPTION OF THE EMBODIMENTS

Hereinafter, embodiments of the present disclosure will be described with reference to the drawings. Note that the relative arrangement, apparatus shape, and the like of each constituent element of the apparatus used in these embodiments are mere illustrative, and are not limited to only these. The same members are denoted by the same reference signs, and repetitive description is omitted as appropriate.

### Embodiment 1

In the case of placing a book document on a platen glass for scan, a method for scanning by causing an end portion of a page which is desired to be read in the book document to be aligned with and to abut on an end portion of a platen glass is known. However, if a document itself is thick, it is difficult to cause an end portion of a page to abut on the end portion of the platen glass, sometimes misaligning the page from the document size. Moreover, since there are innumerable types of book designs of book documents, cases occur where fixed sizes cannot be obtained. In the case where a document size is designated such that the book document is fit in a reading range in such cases, the reading region is forced to contain even a sectional portion of the book document or an outside of the document. That is, it can be said that with the conventional techniques, it is very difficult to set only a target page as a reading region in book documents.

On the other hand, the reading of book documents also has problems other than the designation of sizes. Since the shape of a book document changes more easily than a single sheet, even if the end portion were precisely caused to abut on the reference position of the platen glass, distortion would occur because of a failure in causing the binding portion to abut well. In order to reduce the occurrence of this distortion and the like as much as possible, the user needs to check the state of the book document many times and execute the reading while carefully holding the book document, which is burdensome. Moreover, there is also a disadvantage that in the case where a reading region other than a target page is contained as a result of causes of the aforementioned designation of a size or abutting, ink or toner is wasted in the case of copy, for example.

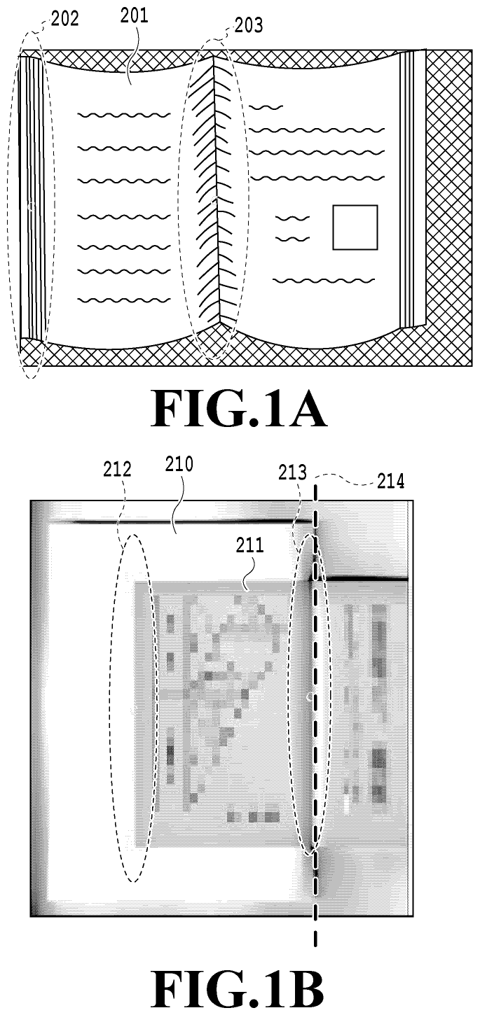

FIGS. 1A and 1B are diagrams for explaining scan of a book document. FIG. 1A shows an example of a result of scan (an example of an image obtained by the scan) in the case where an end portion of a page which is desired to be read in the book document is aligned with and caused to abut on an end portion of a platen glass in the case where the book document is placed on the platen glass, as the conventional method. It is assumed that the page which is desired to be read in the book document is a target page 201. The user attempts scanning by causing the left end portion of the target page 201 to abut on the left end portion of the platen glass. However, since the book document floats above the platen glass due to the thickness, it is difficult to precisely cause the left end portion to abut. There is often a case where as a result of failing to cause the left end portion to completely abut due to slight floating or the like, the page is read containing an image of a thick part of the book on the front edge side as indicated by a front edge portion 202 on the outside of the target page 201. In the case where copy (that is, printing) is conducted in the state where this portion, that is, the thick part of the book on the outside of the target page 201 is contained, ink or toner is wasted for this portion. In addition, a dark image is often obtained because a shadow enters the binding portion 203. Moreover, there is also often a case where the result of reading the target page 201 is distorted by the thickness. Hence, it is difficult to precisely extract and output only the range of the target page 201 (record or print an image as a result of scan).

In contrast, in the present embodiment, the above-described problems are solved by prompting the user to conduct a method for scan which includes interposing a board on the back side of a page which is desired to be read in a book document.

FIG. 1B shows an example of a result of scan (an example of an image obtained by the scan) in the case of conducting scan with board, which will be described in the present embodiment. In FIG. 1B, scan is conducted by placing a book document on a platen glass in a state where a board 210 is interposed on the back of the target page 211, which is a page desired to be read. As a result, an image as shown in FIG. 1B is obtained. Since the board 210 is interposed on the back of the target page 211, there is no other page between the target page 211 and the board 210. Hence, as shown in a front edge portion 212, it is possible to prevent an image of a thick part of a book on the front edge side from being contained on the outside of the target page 201. In the front edge portion 212, the boundary line includes only a boundary portion between the target page 211 and the board 210 and there is not other edge portion that can be falsely recognized as a boundary, and a boundary (edge) on the front edge side of the target page can be precisely extracted. Note that not only the front edge portion 212, which is the side opposite to the binding portion 213, but also boundaries of the front edge portion (the upper side and the lower side of the target page 211 in FIG. 1B), which are sides perpendicular to the binding portion 213, can also be precisely extracted for the same reason. In addition, the range of the target page 211 can be precisely extracted by cropping the target page 211 with a fixed size (standard size, fixed aspect ratio, or standard aspect ratio) based on the three sides other than the boundary on the binding portion side. That is, only the range of the target page 211 can be more precisely extracted and outputted (recorded or printed as an image as a result of the scanning). Moreover, the result of reading the target page 211 can also be prevented from being distorted. In this way, in the case where the scan with board is conducted, only a target page of a book document can be extracted under a condition similar to that for a single sheet. In addition, a more favorable range can be outputted for a document which is difficult to cause to abut on an end of a platen glass like a book document even without precise abutting. Moreover, since the reading region is narrowed down to a target page, ink or toner, which has been wasted in order to reproduce the outside of the target page in the case of the conventional copy, can be reduced.

A control of the above-mentioned scan with board will be described.

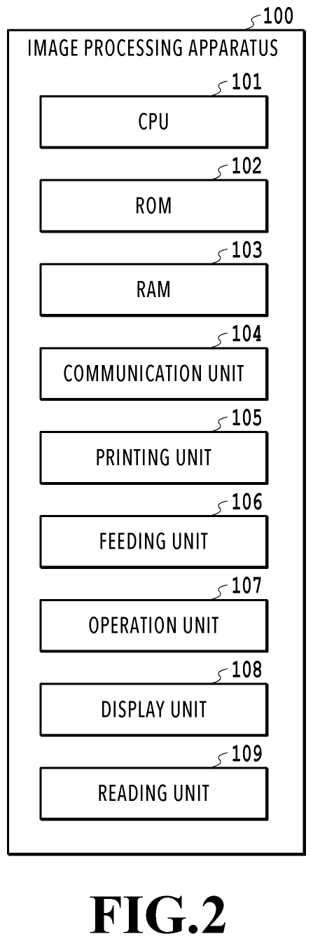

FIG. 2 is a schematic configuration diagram of a reading system according to the present embodiment. In FIG. 2, an image processing apparatus 100 is an apparatus which detects a document region in original image data and includes a CPU 101, a ROM 102, a RAM 103, a communication unit 104, a printing unit 105, a feeding unit 106, an operation unit 107, a display unit 108, and a reading unit 109.

The communication unit 104 is connected to and communicate image data with another device or storage apparatus. The printing unit 105 prints data read by the reading unit 109 on a printing sheet set in the feeding unit 106. The user can input various commands for the image processing apparatus 100 by using various switches and the like included in the operation unit 107. The display unit 108 provides (or notifies) the user with or of various information based on a display control by the CPU 101. In addition, the operation unit 107 may be configured integrally with the display unit 108 as a touch panel. The reading unit 109 is a color scanner of the CCD system or the CIS system which reads a silver halide photograph, a magazine, or the like as image data (digital data). The reading unit 109 scans and reads a document placed on the platen glass (glass plate), which is a flat surface, and outputs an image obtained by the scanning. The CPU 101 can achieve various functions which can be executed by the image processing apparatus 100, by developing programs, which are stored in the ROM 102, in the RAM 103.

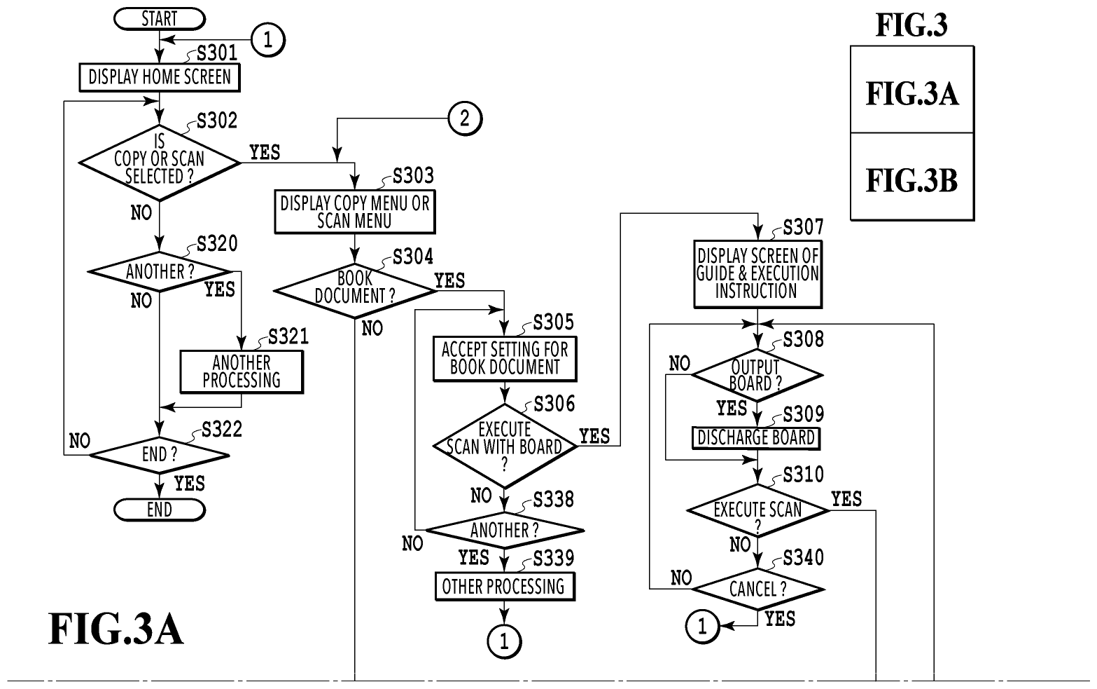

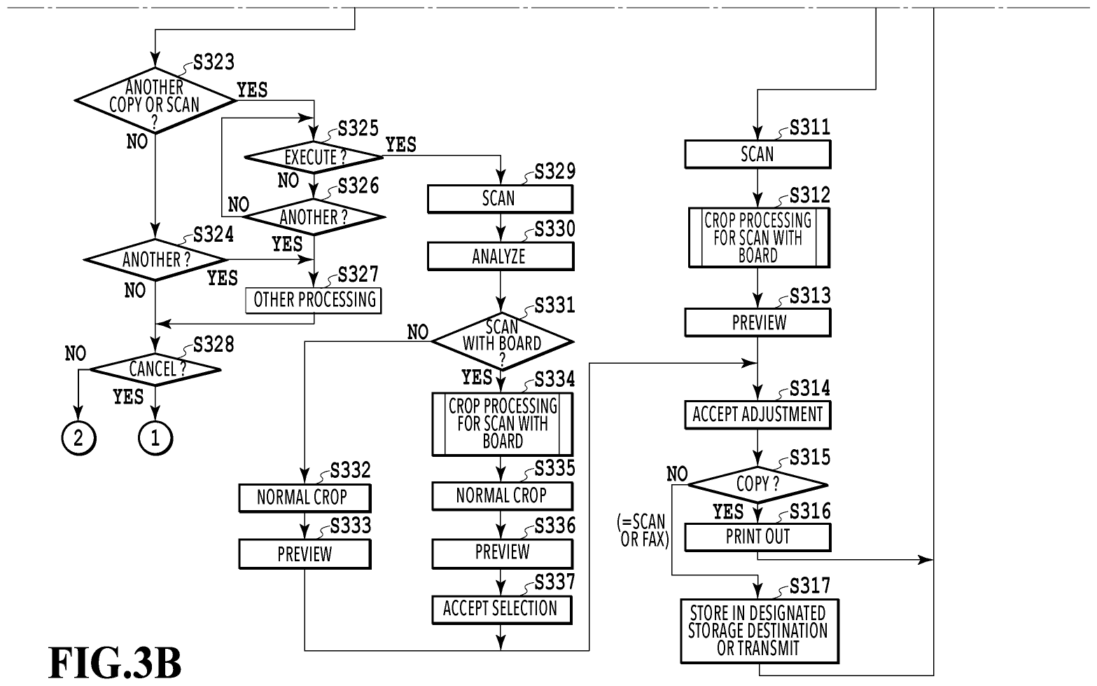

FIG. 3 is a flowchart showing processing by the image processing apparatus 100 according to the present embodiment. A flow of the processing will be described by using FIG. 3. Each processing in the present flowchart is achieved by the CPU 101 of the image processing apparatus 100 developing the program which is stored in the ROM 102, in the RAM 103 and executing the program. In addition, the present processing is started by activating the image processing apparatus 100. Note that mark “S” in the description of each processing of the present flowchart means a step in the flowchart, and the same applies to the following diagrams.

In S301, the CPU 101 displays a home screen on the display unit 108. On the home screen, functions such as copy, scan, and FAX which can be executed by the image processing apparatus 101 are displayed as options. The user selects one of these options to instruct a function which the user wants to execute.

In S302, the CPU 101 determines whether or not the option of copy or scan is selected (that is, whether or not an operation to instruct copy or scan has been conducted) among the options displayed on the home screen. If copy or scan is selected, the CPU 101 proceeds to S303, and if not, the CPU 101 proceeds to S320. In S320, the CPU 101 determines whether or not another operation has been conducted. If another operation has been conducted, the CPU 101 proceeds to S321 and executes processing in accordance with the operation. On the other hand, if it is determined that another operation has not been conducted, the CPU 101 proceeds to S322. In S321, the CPU 101 conducts processing in accordance with the other operation conducted by the user. In S322, the CPU 101 determines whether or not an operation to end the processing has been conducted by the user. The operation to end the processing is an operation of pressing a power button or a sleep button, for example. If it is determined that the operation to end the processing has been conducted, the CPU 101 ends the processing of the present flowchart. If it is determined that the operation to end the processing has not been conducted, the CPU 101 returns to S302 and stands by.

In S303, the CPU 101 displays a menu corresponding to the option selected in S302 on the display unit 108 among a copy menu and a scan menu, and accepts a selecting operation from the user. For example, as the copy menu, a menu screen containing options such as normal copy, book copy, and ID card copy is displayed. The book copy is a function used in the case where the target of scan is a book document (such as a book or a booklet) for more favorably conducting copy of the book document. The scan menu also contains normal scan, book scan, ID card scan, and the like, and particularly contains an option for a book document (book scan).

In S304, the CPU 101 determines whether or not the option of the function for a book document (book copy or book scan) has been selected. If the function for a book document has been selected, the CPU 101 proceeds to S305, and if not, the CPU 101 proceeds to S323. Processing after the CPU 101 proceeds to S323 will be described later. In S305, the CPU 101 displays a setting screen for a book document on the display unit 108 and accepts a setting operation from the user.

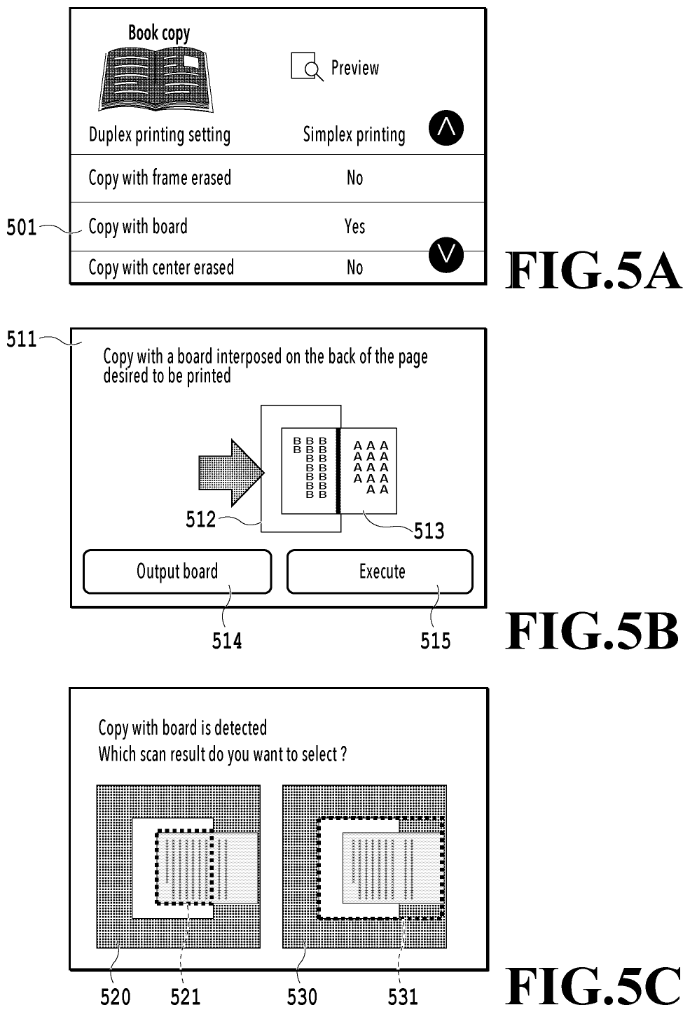

FIGS. 5A to 5C are diagrams showing examples of display of screens displayed on the image processing apparatus in the case of executing book copy. FIG. 5A shows an example of display of a setting screen of book copy (setting screen for a book document) in the case where book copy has been selected. On the setting screen of book copy, setting items for copy of a book document are displayed. These include a setting item 501 of the copy with board. In the case of conducting copy, scan is first conducted, and thereafter, an image based on the scan is printed out. Hence, the setting item 501 of the copy with board is also a setting item of the scan with board. The user can set whether or not to conduct the copy with board by selecting this setting item 501. FIG. 5A is an example of display of setting to conduct the copy with board (effective state). It is also assumed that the setting screen of book scan contains the setting item of the scan with board. Note that the setting screen for conducting the scan with board may provide the copy with board as a part of the print settings as shown in FIG. 5A, or a screen dedicated to the copy with board may be provided.

In S306, the CPU 101 determines whether or not an operation to instruct execution of the scan with board has been made. Specifically, it is determined that the execution of the scan with board has been instructed, by detecting an execution button contained in the operation unit 107 in the state where the copy with board has been set to be effective in the setting item 501 in FIG. 5A, which is the setting screen of book copy, in S305. Similarly in the case where the setting screen of the book scan has been displayed, it is determined that the execution of the scan with board has been instructed, in the case where an execution button (hard key) included in the operation unit 107 is pressed in the state where the setting item of the scan with board has been set to be effective. If the operation to instruct the execution of the scan with board has been made, the CPU 101 proceeds to S307, and if not, the CPU 101 proceeds to S338. In S338, the CPU 101 determines whether or not another operation has been conducted. If another operation has been conducted, the CPU 101 proceeds to S339 and executes processing in accordance with the operation. On the other hand, if it is determined that another operation has not been conducted, the CPU 101 returns to S305. After ending the processing of S339, the CPU 101 returns to S301.

In S307, the CPU 101 displays a guide screen about the scan with board on the display unit 108. FIG. 5B shows an example of display of the guide screen about the scan with board. In a message 511, a message saying that “Copy with a board interposed on the back of the page desired to be printed” is displayed. This message is a display indicating how to conduct the scan with board to the user, and is also a display indicating that it is necessary for the user to conduct a work of interposing a board on a document and prompting the user to interpose a board. In the guide screen, a schematic diagram is also displayed. The schematic diagram (guide image) contains a board image 512 and a book document image 513 as display elements, in which a state where the board image 512 is interposed with respect to the book document image 513 is shown. Displaying the schematic diagram allows the user to more surely understand what the scan with board is like. In addition, the user can work on the scan with board without confusion. A board output button 514 is an operation icon (display item) for instructing discharge of paper serving as a board from a discharge section. An execution button 515 is an operation icon (display item) for accepting an instruction to start the scan processing (reading processing) of the scan with board. Note that as shown in FIG. 5B, the guide screen includes an execution button for outputting the board and an execution button for reading together with a guidance display for guiding the method for interposing a board, the guidance display and the execution buttons may be displayed separately.

In S308, the CPU 101 determines whether or not the board output button 514 has been operated (has been touched). If the board output button 514 has been operated, the CPU 101 proceeds to S309, and if not, the CPU 101 proceeds to S310.

In S309, the CPU 101 conveys a sheet set (loaded, stored) in the feeding unit 106 and discharges the sheet to the discharge section (discharge tray) as a blank sheet without printing. The user can take the sheet thus discharged and interpose the sheet in a book document as the board. In this way, even in the case where the user does not have a board, the user can easily obtain paper serving as the board. In addition, there is no need to open or close a cover or a cassette of the feeding unit. Hence, there is no need to conduct a sheet setting operation associated with the opening or closing of the feeding unit. In the case where a plurality of types of sheets are stored, a sheet to be discharged as a board is assumed to be ordinary paper having a size of A4 or more. The reason for the size of A4 or more is, as mentioned before, that part other than the target page needs to be prevented from being captured on the outside of the target page and that the board needs to be larger than one page of a book to allow the board to come on the background of the target page and to make it easy to extract a boundary. In addition, the reason for using ordinary paper as a board is that photograph paper or glossy paper is expensive for use as a board. Note that in a fee-based copy machine or the like placed in a shop or the like, this discharge of a board is made available for free. That is, the board is discharged from the discharge section without reducing the money displayed in accordance with the inputted money. In addition, although in the present embodiment, a board of a blank sheet without printing is discharged, a board on which a single-color filling, a design, a pattern, or the like is printed may be discharged, so that the board can be easily distinguished from a target page. In addition, a sheet may be discharged after a text indicating that the sheet should be used as a board for the scan with board, a text saying that “Start copy with this sheet interposed on the back of the page desired to be printed”, or a schematic diagram as shown in FIG. 5B is printed on the sheet to be discharged as the board.

Note that although in the present embodiment, an example of discharging a board for the scan with board in which scan is conducted with the board interposed in a book document has been described, this mechanism of discharging a board can also be applied favorably to a case where a board is effective for a document other than a book document. For example, a board can be effectively used also in a case of reading a thin document of B4 or a size smaller than A4, such as a photograph of L size. By conducting scan with the back surface of a document covered with a board, the region of a photograph original can be more easily recognized in image processing and automatic cropping of the region of the photograph original can be more precisely conducted. In the case of such scan as well, it is favorable that a display item corresponding to the board output button 514 is displayed, a sheet set (loaded, stored) in the feeding unit 106 is conveyed and discharged to the discharge section (discharge tray) as a board in accordance with operations.

In S310, the CPU 101 determines whether or not the execution button 515 has been operated (touched). If the execution button 515 has been operated, the CPU 101 proceeds to S311, and if not, the CPU 101 proceeds to S340.

In S340, the CPU 101 determines whether or not a canceling operation has been made by the user. If it is determined that the canceling operation has been made, the CPU 101 returns to S301 and displays the home screen. If it is determined that the canceling operation has not been made, the CPU 101 returns to S308.

In S311, the CPU 101 drives the reading unit 109 (reading sensor) for scan to read (scan) a document placed on the platen glass. As a result, an image of a scan result as shown in FIG. 1B mentioned before is obtained.

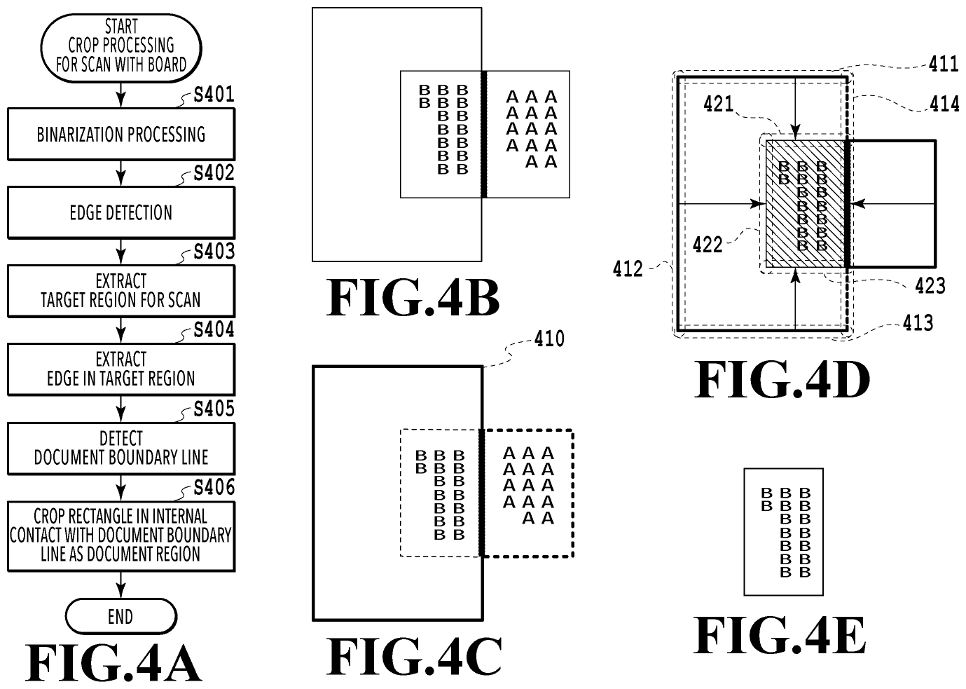

In S312, the CPU 101 conducts crop processing for the scan with board on the image obtained by the scan of S311. This processing will be described later by using FIG. 4. This processing is processing of automatically determining and setting a crop region even without an operation of designating the crop region (cropping region, trimming region) from the user.

In S313, the CPU 101 displays an image obtained as a result of the crop processing for the scan with board of S312 on the display unit 108 as a preview. At this point, the image obtained by the scan of S311 has not been deleted but stored in the ROM 102 or the RAM 103.

In S314, the CPU 101 accepts an adjusting operation of a crop position (crop range, cropping range, trimming range) from the user for the preview display displayed in S313. This makes it possible to extract a better range as intended by the user. In the case where an end of the adjustment is instructed, the CPU 101 proceeds to S315.

In S315, the CPU 101 determines whether or not the instructed processing has been copy. If copy has been selected in S302, the CPU 101 determines that the processing has been copy in the present processing. If the processing has been copy, the CPU 101 proceeds to S316, and if the processing has not been copy (that is, if the instructed processing has been scan), the CPU 101 proceeds to S317. Note that it is assumed that a case where processing of scanning an image and transmitting the image to a designated transmission destination (transmission using an e-mail or transmission using FAX) is also included in the scan instruction.

In S316, the CPU 101 prints out an image of a range obtained by the crop processing of S312 or an image of a range reflecting the adjusting operation accepted in S314, of the image obtained by the scan of the S311. More specifically, the CPU 101 conducts control to convey a sheet set (loaded, stored) in the feeding unit 106, print an image of the range obtained by the crop processing of S312 or an image of the range reflecting the adjusting operation accepted in the S314 on the sheet, and output the sheet to the discharge section. In the case where the adjusting operation from the user has not been made in S314, the image of the range obtained by the crop processing of the S312 is printed, while in the case where the adjusting operation from the user has been made in S314, the image of the range reflecting the adjusting operation is printed. This makes it possible to obtain a result in which the front portion of the page with the board interposed on the back by the user is more favorably printed. After ending the processing of S316, the CPU 101 returns to S308.

In S317, the CPU 101 stores (outputs) an image of the same range as the range described in S316 in a designated storage destination as an image file, or transmits the image to a designated transmission destination.

The above-described processing of S301 to S317 makes it possible to obtain an image in which a front portion of a page with a board interposed on the back by the user is more favorably extracted. After ending the processing of S317, the CPU 101 returns to S308. Note that for the processing of S302 to S307, a configuration in which for example, a short-cut button or the like is created to omit a step, or the like may be employed.

The description is returned to the processing in the case where it is determined that it is not for a book document in S304. In S323, the CPU 101 determines whether or not another copy or scan function without a designating operation of printing a book document has been selected. If another copy or scan function has been selected, the CPU 101 proceeds to S325, and if not, the CPU 101 proceeds to S324.

In S324, the CPU 101 determines whether or not another operation has been conducted. If another operation has been conducted, the CPU 101 proceeds to S327 and executes processing in accordance with the operation. On the other hand, if it is determined that another operation has not been conducted, the CPU 101 proceeds to S328. In S328, the CPU 101 determines whether or not a canceling operation has been made by the user. If it is determined that the canceling operation has been made, the CPU 101 returns to S301 and displays the home screen. If it is determined that the canceling operation has not been made, the CPU 101 returns to S303 and continues displaying the copy menu or the scan menu.

In S325, the CPU 101 determines whether or not an operation of instructing execution of another copy or scan has been made. For example, in the case where an execution button (hard key) included in the operation unit 107 has been pressed, it is determined that the operation of instructing execution of copy or scan has been made. If the operation of instructing execution of copy or scan has been made, the CPU 101 proceeds to S329, and if not, the CPU 101 proceeds to S326.

In S326, the CPU 101 determines whether or not another operation has been conducted. If another operation has been conducted, the CPU 101 proceeds to S327 and executes processing in accordance with the operation. On the other hand, if it is determined that another operation has not been conducted, the CPU 101 returns to S325 and stands by until an operation is made by the user.

In S329, the CPU 101 drives the reading unit 109 to read (scan) a document set on the platen glass. In S330, the CPU 101 analyzes an image obtained by the scan of S329. In S331, the CPU 101 determines whether or not the image obtained by the scan of S329 is an image subjected to the scan with board as a result of the image analysis of S330. If it is determined that the image is an image of a book document with a board interposed like the scan with board, the CPU 101 proceeds to S334, and if not, the CPU 101 proceeds to S332. The determination on whether or not the image is an image subjected to the scan with board may be made by using a learning model caused to learn a large number of images obtained by conducting the scan with board as described in FIG. 1A as teacher data. In addition, the determination may be made in accordance with such condition setting that a boundary of three sides could be detected inside a white blank portion (that is, a region conceivable to be a board) surrounded by a boundary of three sides or more (that is, a region conceivable to be a target page could be detected inside the board).

In S332, the CPU 101 conducts normal crop processing. The normal crop processing is, for example, such crop processing that crops a closed region surrounded by four sides which is in internal contact with a boundary extracted by edge detection. In S333, the CPU 101 displays an image of the crop range obtained as a result of the processing of S332 on the display unit 108 as a preview. Thereafter, the CPU 101 proceeds to S314 mentioned before.

In S334, the CPU 101 conducts the crop processing for the scan with board on the image obtained by the scan of S329 in the same manner as in S312. In S335, the CPU 101 conducts normal crop processing, which is different from the processing of S334, on the image obtained by the scan of S329. This is the same processing as S332.

In S336, the CPU 101 displays an image of a crop range obtained as a result of S334 and an image of a crop range obtained as a result of S335 on the display unit 108 as previews. An example of display at this time is shown in FIG. 5C. In an image 520 on the left side, a range surrounded by a dotted line 521 (crop range, trimming frame) indicates the image of the crop range obtained as a result of S334. In an image 530 on the right side, a range surrounded by a dotted line 531 (crop range, trimming frame) indicates the image of the crop range obtained as a result of S335. In the present embodiment, it is assumed that the dotted line 521 and the dotted line 531 are also displayed. The user can select an image that suits the intention by visually comparing the image 520 and the image 530.

In S337, the CPU 101 accepts a selecting operation of either the image 520 (the crop range indicated by the dotted line 521) or the image 530 (the crop range indicated by the dotted line 531) from the user. The CPU 101 proceeds to S314 and conducts the aforementioned processing by using the crop range selected by the user as a reference. Note that the processing of S335 to S337 may be omitted, and in this case, the CPU 101 may proceed from S334 to S314.

The above-described processing described in S323 to S337 makes it possible to conduct cropping in a crop range in accordance with the scan with board on an image which is assumed to have been subjected to the scan with board even in the case where the user has not conducted an operation of instructing execution of the scan with board beforehand. This makes it possible for the user who is accustomed to the scan with board to utilize the scan with board without burden even in the case where the user does not instruct the scan with board every time.

Note that in the case where execution of another copy or scan has been instructed in S325, a configuration may be employed in which pre-scanning is conducted, and it is determined whether or not the document is a book document based on an image obtained by the pre-scanning. In addition, in this case, if it is determined that the document is a book document, the display of S307 may be conducted to prompt the user to conduct the scan with board. This make it possible for even a user who does not recognize the presence of the scan with board to conduct the scan with board in a scene in which the scan with board is favorably conducted.

FIGS. 4A to 4E are a flowchart showing a detail of the crop processing (S312, S334) for the scan with board in FIG. 3 and schematic diagrams of ranges of data to be processed. In S401, the CPU 101 conducts binarization processing of a read image. In addition, in S402, the CPU 101 conducts edge detection to extract a region of the document. The processing so far is the same as normal multi-crop processing. A result of the multi-crop processing is as shown in the schematic diagram of FIG. 4B.

In S403, the CPU 101 limits the analysis target to a region of the document in order to extract a page region of the book document. This corresponds to the region indicated by the dotted line of FIG. 4C. In S404, the CPU 101 conducts the edge detection in the limited region again. Although the edge detected in S402 was an edge containing a board portion, the page region of the book document is on the inner side of the board portion. Therefore, in S404, an edge located further inward of the region indicated by the dotted line portion of FIG. 4C is attempted to be detected. In S405, the CPU 101 extracts a document boundary line based on the edge detection of S404. In the present embodiment, the extraction of a document boundary line is conducted by a method including determining the position of a contour of the document by means of a histogram mode as shown in FIG. 4D and approximating the contour to a straight line, on the basis of the edge extraction method. Note that the extraction of a document boundary line may be conducted by using another method. In addition, the edge detection in a target region is first conducted inward from three sides (sides 411, 412, and 413) of a board portion, which are edges detected in S402. Edges obtained as a result of conducting the detection inward from the respective sides are three sides (sides 421, 422, and 423) of the document page of the book. A document boundary line of the remaining one side (a side corresponding to the binding portion) can be determined based on an extension line 414 of the side of the board portion, for example. Alternatively, a document boundary line can be determined by cutting in a predetermined aspect ratio based on the other three sides. Alternatively, the above-mentioned methods may be used in combination. In this way, the document boundary line obtained in S405 is composed of four sides including three sides, which are end portions of the page of the book document, and one side, which corresponds to the binding portion.

In S406, the CPU 101 crops a rectangle which is in internal contact with the document boundary line as a document region. This is a region corresponding to a shaded portion 415 of FIG. 4D. In addition, a result of cropping is as shown in FIG. 4E. This region is a region to be outputted as a region of the target page, and is a portion obtained by deleting a part on the opposite side to the board in a portion corresponding to the book document in the image obtained by scanning in the state where the book document and the board are placed on the platen glass. After the processing of S406, the CPU 101 ends the processing of the present flowchart. The detail of the processing conducted in S312 and S334 is as described above. In the case where scanning is conducted in the state where a board is interposed in a book document (in the state where the book document and the board are overlapped) by the present processing, cropping as shown in FIG. 4E can be conducted by cropping a portion in which the book document and the board overlap each other.

### Other Embodiments

The above-mentioned various controls described as being conducted by the CPU 101 may be conducted by one piece of hardware, or the entire apparatus may be controlled by dividing the processing into a plurality of pieces of hardware (for example, a plurality of processors or circuits).

In addition, although the present invention has been described in detail based on its preferred embodiments, the present invention is not limited to these specific embodiments, and the present invention encompasses various modes within a range without departing from the gist of the invention. Moreover, each above-mentioned embodiment is mere showing one embodiment of the present invention, and these embodiments can be combined as appropriate.

In addition, in the above-mentioned embodiment, the case where the present invention is applied to the image processing apparatus 100 including the printing unit has been described as an example. However, the present invention is not limited to this example and can be applied to an image processing apparatus and an information processing apparatus which can conduct controls about scanning. For example, although in the above-mentioned embodiment, an example in which extraction of a crop region and display of guidance are conducted in the display unit of the main body of the printer has been described, the configuration is not limited to this. In the case where an instruction for scanning can be made from an electronic device such as a PC or a smartphone (which is a type of image processing apparatus and is also an information processing apparatus) to a scanner or printer including a reading unit, the guidance of FIG. 5B may be displayed on the PC or the smartphone. In addition, it is possible to obtain an image as a result of scanning before cropping (an image as shown in FIG. 1B) in a PC or a smartphone and to conduct the crop processing of FIG. 4 in the PC or the smartphone. That is, the present invention can be applied to a personal computer and a PDA, a mobile phone and a portable image viewer, a printer apparatus, a scanner apparatus, a digital photo frame, a game console, an e-book reader, and the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131848, filed Aug. 14, 2023, which is hereby incorporated by reference wherein in its entirety.

What is claimed is:

1. An image processing apparatus, comprising at least one memory and at least one processor and/or at least one circuit which function as:
a scan control unit which conducts control to scan a scan target; and
an output unit which, even in a case where there is no operation of designating a cropping region from a user, crops, from an image obtained by scanning in a state where a book document and a board are placed on a platen glass, a portion obtained by deleting a part on an opposite side to the board in a portion corresponding to the book document, and outputs the cropped portion.

2. The image processing apparatus according to claim 1, wherein the output unit conducts the cropping based on acceptance of an instruction that the scan target is a book document.

3. The image processing apparatus according to claim 1, wherein the output unit conduct the cropping which is for a book document based on an event that it is detected by the scanning by the scan control unit that the scan target is a book document and a board placed on the platen glass.

4. The image processing apparatus according to claim 3, wherein the output unit also conducts cropping which is not for a book document in a case where it is detected by the scanning by the scan control unit that the scan target is a book document and a board placed on the platen glass.

5. The image processing apparatus according to claim 4, further comprising a display control unit which conducts control to display an image obtained by the cropping which is for a book document and an image obtained by the cropping which is not for a book document such that a user can select one of the images.

6. An image processing apparatus, comprising at least one memory and at least one processor and/or at least one circuit which function as:
a scan control unit which conducts control to scan a scan target; and
a display control unit which conducts control to display guidance about scanning with a board interposed in a book document.

7. The image processing apparatus according to claim 6, further comprising:
an output unit which, even in a case where there is no operation of designating a cropping region from a user, crops, from an image obtained by scanning in a state where a book document and a board are placed on a platen glass, a portion obtained by deleting a part on an opposite side to the board in a portion corresponding to the book document, and outputs the cropped portion.

8. The image processing apparatus according to claim 7, wherein the display control unit conducts control to display the guidance before scanning by the scan control unit, based on acceptance of an instruction that the scan target is a book document.

9. The image processing apparatus according to claim 7, wherein the display control unit displays the guidance in a case where it is detected that the scan target is a book document based on scanning by the scan control unit.

10. A method for controlling an image processing apparatus comprising:
conducting control to scan a scan target; and
even in a case where there is no operation of designating a cropping region from a user, cropping from an image obtained by scanning in a state where a book document and a board are placed on a platen glass, a portion obtained by deleting a part on an opposite side to the board in a portion corresponding to the book document, and outputting the cropped portion.
